(19) United States
(12) Patent Application Publication
(10) Pub. No.: US 2016/0181666 A1
(43) Pub. Date: Jun. 23, 2016

(54) CONDUCTIVE AND LIQUID-RETAINING STRUCTURE

(71) Applicant: HYUNDAI MOTOR COMPANY, Seoul (KR)

(72) Inventors: Yoon Ji LEE, Gyeonggi-do (KR); Dae Gun JIN, Gyeonggi-do (KR); Hee Jin WOO, Gyeonggi-do (KR); Hee Yeon RYU, Gyeonggi-do (KR); Sang Jin PARK, Gyeonggi-do (KR)

(73) Assignee: HYUNDAI MOTOR COMPANY, Seoul (KR)

(21) Appl. No.: 14/948,824

(22) Filed: Nov. 23, 2015

(30) Foreign Application Priority Data
Dec. 23, 2014 (KR) 10-2014-0187446

(51) Int. Cl. H01M 10/0585; H01M 10/052

(52) U.S. Cl. CPC H01M 10/0585; H01M 10/052

(57) ABSTRACT

A lithium-sulfur battery with improved cell performance may include a carbon layer. A high loading anode is needed to increase energy density, but it is difficult to express capacity when testing a cell of the high loading anode. To retain electrolyte solution so as to improve cell performance when loading is increased, a conductive structure may be inserted to the cell, thereby providing not only electrolyte solution-retaining but also a reaction site.

### CROSS-REFERENCE TO RELATED APPLICATION

This application claims priority under 35 U.S.C. §119(a) to and the benefit of Korean Patent Application No. 10-2014-0187446 filed on Dec. 23,2014 with the Korean Intellectual Property Office, the entire contents of which are incorporated herein by reference.

### TECHNICAL FIELD

The present disclosure relates to a structure retaining electrolyte in a secondary battery.

### BACKGROUND

Fuel cell is a device directly converting chemical energy of a reactant such as a fuel and an oxidizing agent to direct current (DC) electricity. The fuel cell is more efficient than not only a portable power storage system such as a lithium ion battery is but also a power generator by combusting, for example, fossil fuel, and therefore, its application has been extended to a variety of areas. In general, fuel cell techniques include many kinds of fuel cells such as alkali fuel cell, polymer electrolyte-type fuel cell, phosphoric acid fuel cell, molten carbonate fuel cell, solid oxide fuel cell and enzyme fuel cell. Fuel cells, which are very important today, may be classified into at least four categories, i.e., (i) a fuel cell using compressed hydrogen (H₂) as a fuel, (ii) a proton exchange membrane (PEM) or a polymer electrolyte membrane (PEM) fuel cell using alcohol such as methanol (CH₃OH), metal hydride such as sodium borohydride (NaBH₄), hydrocarbon, or other fuels converted to a hydrogen fuel, (iii) a PEM fuel cell or a direct oxidation fuel cell, which can directly consume a non-hydrogen fuel, and (iv) a solid oxide fuel cells (SOFC) directly converting a hydrocarbon fuel to electricity at a high temperature.

On the other hand, as one type of a non-aqueous electrolyte solution secondary battery, a lithium ion secondary battery is commercialized. For example, a lithium ion secondary battery may contain: an anode containing lithium cobalt oxide (for example LiCoO₂), a cathode containing a graphitic material or a carbonaceous material, a non-aqueous electrolyte solution based on an organic solvent dissolving a lithium salt, and a porous membrane as a separator. As a solvent of the electrolyte solution, a non-aqueous solvent having low viscosity and low melting point is used.

Further, a lithium-sulfur battery, capitalized as the brightest battery because an active material of the lithium-sulfur battery is cheap and environment-friendly, has is high energy density because energy density of lithium is 3830 mAh/g, and energy density of sulfur is 1675 mAh/g. This lithium-sulfur battery is a secondary battery, which uses a sulfur-based compound having a sulfur-sulfur combination as an anode active material, and a carbon-based material where alkali metal such as lithium or metal ion such as lithium ion is intercalated or deintercalated, as a cathode active material. It stores and produces electrical energy using oxidation-reduction reaction, wherein oxidation number of S is reduced as S-S combination is broken during reduction reaction (when discharged), and S-S combination is formed again as oxidation number of S is increased during oxidation reaction (when charged).

A lithium-air battery refers to a battery using lithium (Li) metal as a cathode and oxygen (O₂) in the air as an anode active material, and is a new energy storage method, which can replace the existing lithium ion battery. The lithium-air battery is a battery system where secondary battery and fuel cell techniques are combined. In a cathode of the lithium-air battery, oxidation/reduction reaction of lithium occurs, while in an anode of the lithium-air battery, reduction/oxidation reaction of oxygen introduced from outside occurs. It has an advantage that theoretical energy density of the lithium-air battery is as high as 11,140 Wh/kg, compared to other secondary batteries. In general, the lithium-air battery includes a cathode, an anode, an electrolyte placed between the cathode and the anode, and a separator. In general, porous carbon is used as a member of the anode. However, using porous carbon as a member of the anode is disadvantageous, because charge/discharge storage capacity, when measured, is very low and charge/discharge cycle life is short due to its low activity to the reduction/oxidation reaction of oxygen.

The suggested next generation secondary battery uses the aqueous or non-aqueous solvent and electrolyte as a reaction site, but expression of battery capacity may be difficult because a high loading anode is needed as a result of cell design fit to the targeted energy density. Thus, electrolyte solution retention thus is necessary as the anode has a high loading, and as the result of study, it has been found that when inserting a glass filter (G/F), capacity expression becomes easy in the electrode of high loading (2.5 mg/cm²_S) or more.

However, there is a defect that the reaction site in a secondary battery, which uses an anode having high loading of 5 mg/cm²_S or more, is not enough only with the liquid-retaining structure of the glass filter structure.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

The present invention provides an electrolyte-retaining structure in a secondary battery, which plays a role of providing a reaction site as well as expresses electrode capacity, so as to improve battery performance. The present invention relates to combination of a general anode of a secondary battery and a liquid-retaining structure. The invention is specifically described by mentioning a fuel cell structure or a lithium-sulfur battery structure, and an application of the liquid-retaining structure of the present invention includes a plurality of battery structure types, which can be applied to a corresponding technical field.

In one aspect, the present invention provides a lithium-sulfur secondary battery comprising a cathode, a separation membrane, a conductive and liquid-retaining structure, and an anode. The cathode, the separation membrane, the conductive and liquid-retaining structure, and the anode may be sequentially stacked. The conductive and liquid-retaining structure may have a thickness of 5 to 1000 μm, an areal weight of 10 to 120 g/m² range, and porosity of 70 to 95% range.

In a preferred embodiment, the conductive and liquid-retaining structure may be carbon paper, carbon felt, carbon veil, woven-carbon, carbon nanotube paper, or a laminated structure of at least two selected therefrom.

In another preferred embodiment, the thickness may be 50 to 500 μm.

In still another preferred embodiment, the thickness may be 20 to 350 μm.

In still yet another preferred embodiment, the loading amount of the anode may be 3 to 10 mg/cm².

In another aspect, the present invention provides a method for manufacturing the lithium-sulfur secondary battery. The conductive and liquid-retaining structure may be laminated after casting an active material to the anode, and then assembled with the cathode and the separation membrane, or it may be assembled between the separation membrane and the anode in the cell assembly step.

In a preferred embodiment, the conductive and liquid-retaining structure may be carbon paper, carbon felt, carbon veil, gas diffusion layer (GDL), carbon nanotube paper or a laminated structure of at least two selected therefrom.

In another preferred embodiment, the thickness may be 50 to 500 μm.

In still another preferred embodiment, the thickness may be 20 to 350 μm.

In still yet another preferred embodiment, the loading amount of the anode may be 3 to 10 mg/cm².

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered is vehicles.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1A-1D respectively show a low-magnification image, a high-magnification image, a cross sectional image, and a surface of carbon felt applicable to form a conductive and liquid-retaining structure employed by a secondary battery according to an embodiment of the present disclosure;

FIG. 2 is constitution of a commercialized fuel cell GDL and design for using thereof as a battery according to an embodiment of the present disclosure;

FIG. 3 is a graph showing capacity and life when a glass filter (GF);

FIG. 4 is a graph showing capacity and life (1 to 50 cycles) according to carbon paper thickness;

FIG. 5 is a diagram showing a method for manufacturing a battery electrode using sulfur;

FIG. 6 is a diagram showing a method for assembling a battery electrode without a conductive and liquid-retaining structure;

FIG. 7 is a diagram showing a method for assembling an electrode to which a conductive structure according to an embodiment of the present disclosure is applied;

FIG. 8 is diagrams showing carbon paper, Ketjen black, high specific surface area conducting film or a carbon structure layer combining thereof, used as a conductive structure according to an embodiment of the present disclosure;

FIG. 9 is a graph comparing capacity of Inventive Example (using a conductive structure at high loading 5 mg/cm²_S) according to an embodiment of the present disclosure and Comparative Example; and

FIG. 10 is a graph comparing life of Inventive Example (using a conductive structure at low loading 2.5 mg/cm²_S) according to an embodiment of the present disclosure and Comparative Example.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A lithium-sulfur secondary battery according to an embodiment of the present disclosure may include a cathode, a separation membrane, a conductive and liquid-retaining structure, and an anode. The cathode, the separation member, the conducive and liquid-retaining structure, and the anode may be sequentially stacked. The conductive and liquid-retaining structure may have a thickness of 5 to 1000 μm, areal weight of 10 to 120 g/m² range, and porosity of 70 to 95% range.

The conductive and liquid-retaining structure may be carbon paper, carbon felt, carbon veil, GDL (gas diffusion layer), or carbon nanotube paper, or a laminated structure including at least two selected therefrom. The loading amount of the anode may be 3 to 10 mg/cm².

The conductive and liquid-retaining structure may be laminated after casting an active material to the anode, and then assembled with the cathode and the separation membrane, or it may be assembled between the separation membrane and the anode in the cell assembly step.

According to an embodiment of the present disclosure, a conductive and liquid-retaining structure may be formed on an anode which may be formed, for example, by s Al-casting. According to one embodiment, a gas diffusion layer (GDL, for a fuel cell) may be used as a conductive and liquid-retaining structure, but any carbon structure layer having porosity, pore size and thickness suggested in the present disclosure may be alternatively used .

On the contrary, in a conventional lithium-sulfur battery, an electrode may be formed by mixing an active material, a conductive material and a binder to almost homogeneous state and then casting thereof (see FIG. 5). In the conventional lithium-sulfur battery, no conductive and liquid-retaining structure is formed between a separation membrane and an anode.

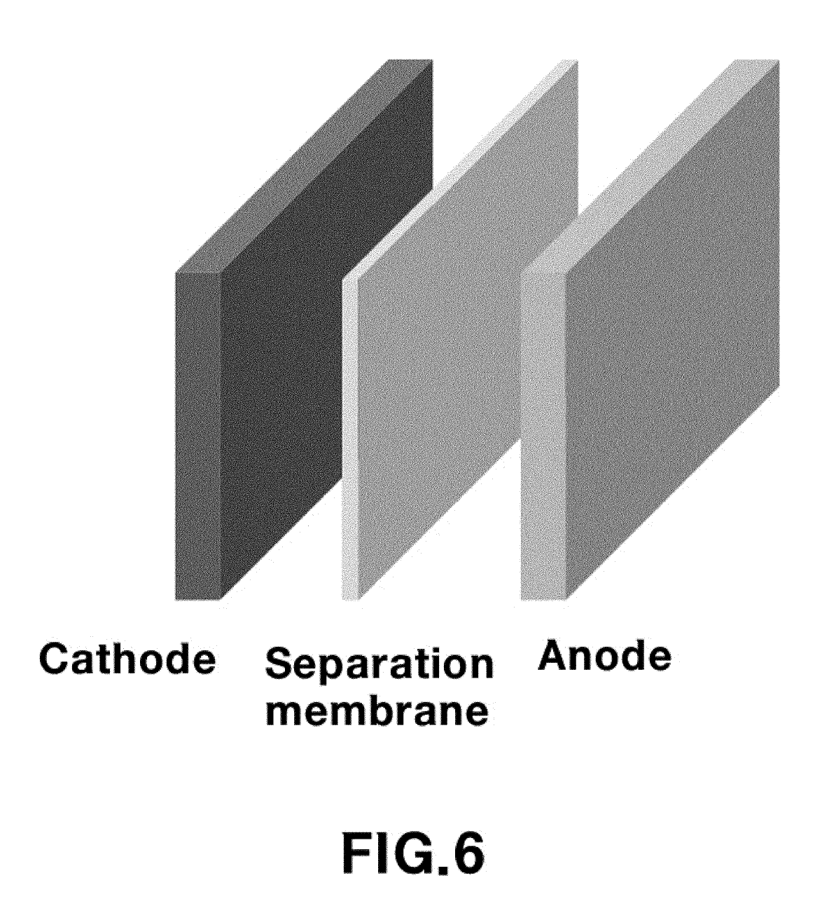

As shown in FIG. 6, the conventional method for assembling an electrode used a method of forming a cell with a cathode/separation membrane/anode and an electrolyte. During reaction, the active material is converted to PS, an electrolyte-soluble material, and then when the material is melted and escapes from the electrolyte, the active material is led to loss rate. Therefore, there is a problem of decrease of life maintenance rate and the like.

Further, there is also a problem that performance of a charging and discharging cell where the active material is highly loaded (high loading electrode) is deteriorated.

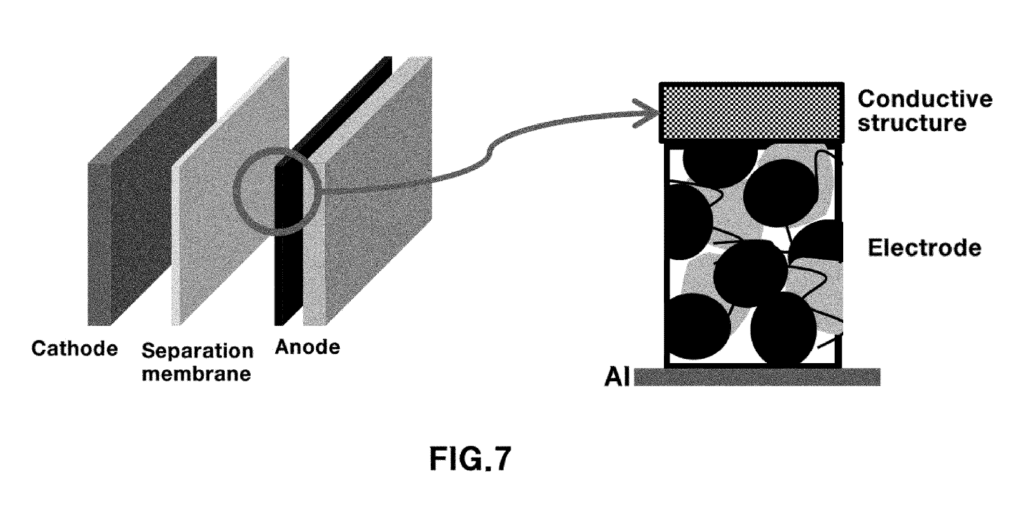

As shown in FIG. 7, in the anode having the conductive structure of the present invention, a cell is formed by casting an anode active material to metal (for example, aluminum substrate) to manufacture an anode, and at the same time it is assembled with a carbon structure layer having specific surface area and porosity in the range suggested in the present invention as a conductive structure, followed by assembled to an entire electrode, or by manufacturing an anode first and then assembling cathode/separation membrane/conductive structure/anode in order when assembling the entire electrode.

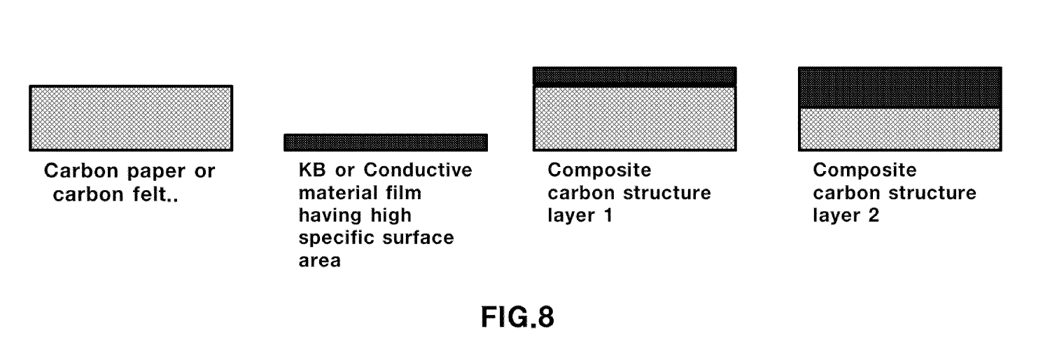

Types of the conductive structure, which can be assembled, are not limited. The conductive structure may be a commercialized one or may be manufactured during fabricating the electrode of the lithium-sulfur battery (see FIG. 8). The commercialized one may be, for example, carbon paper, carbon felt, carbon veil, GDL and carbon nanotube paper (CNT paper).

Type of the conductive material for forming the conductive structure may be carbon fiber, Ketjen black (KB), super C and the like, but not limited thereto.

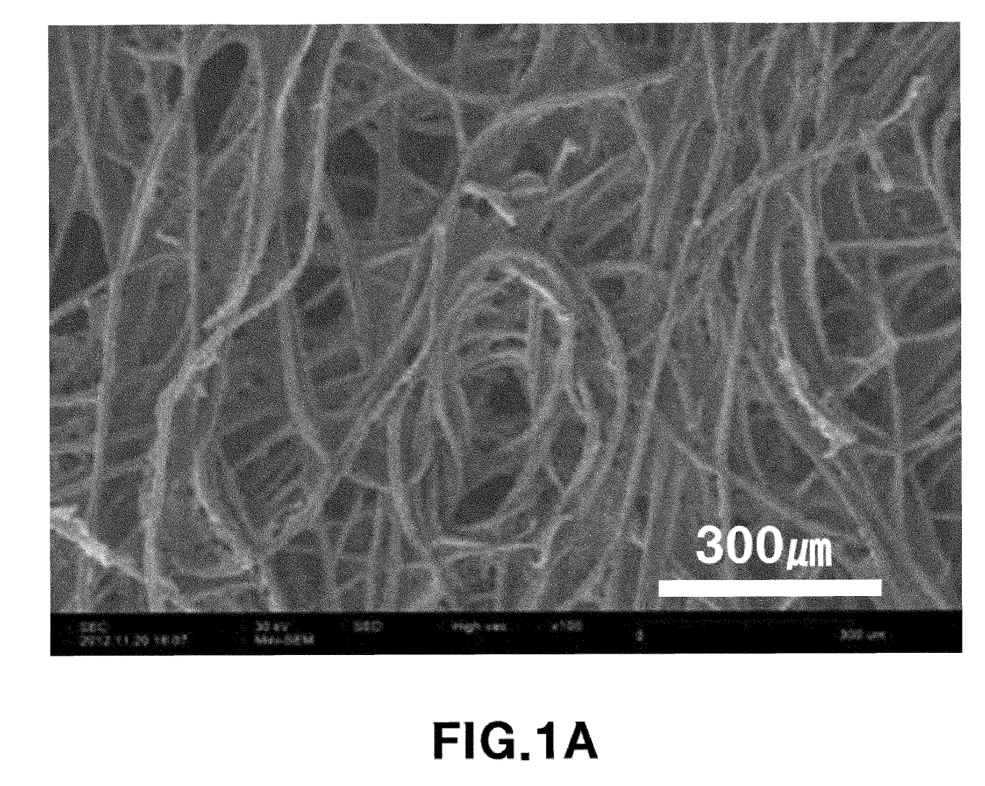

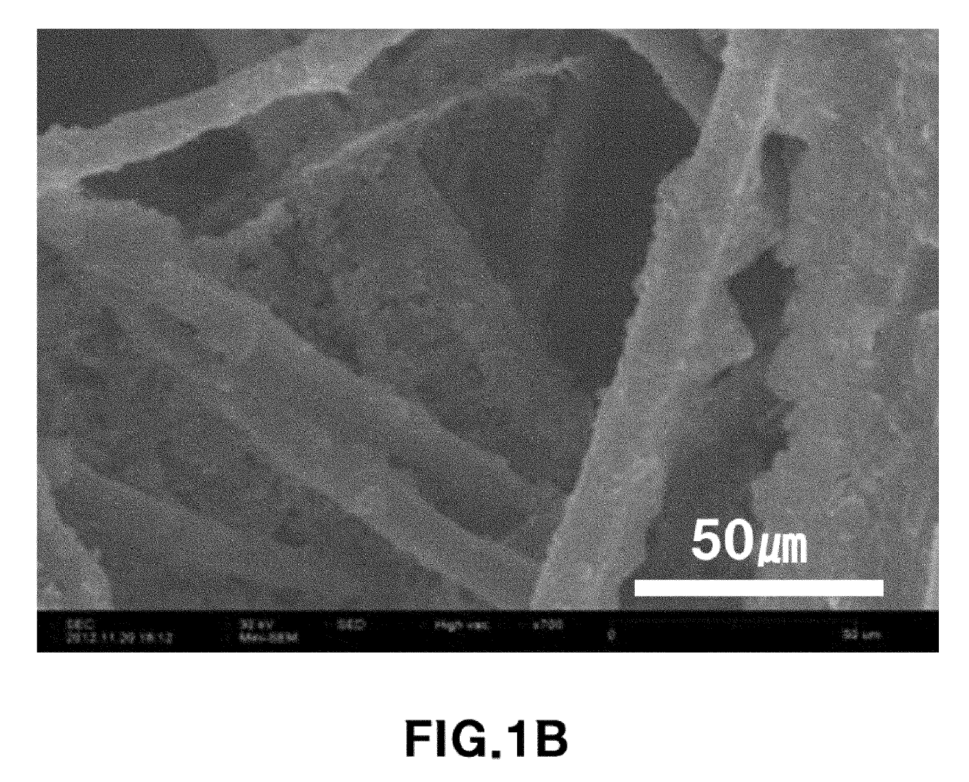

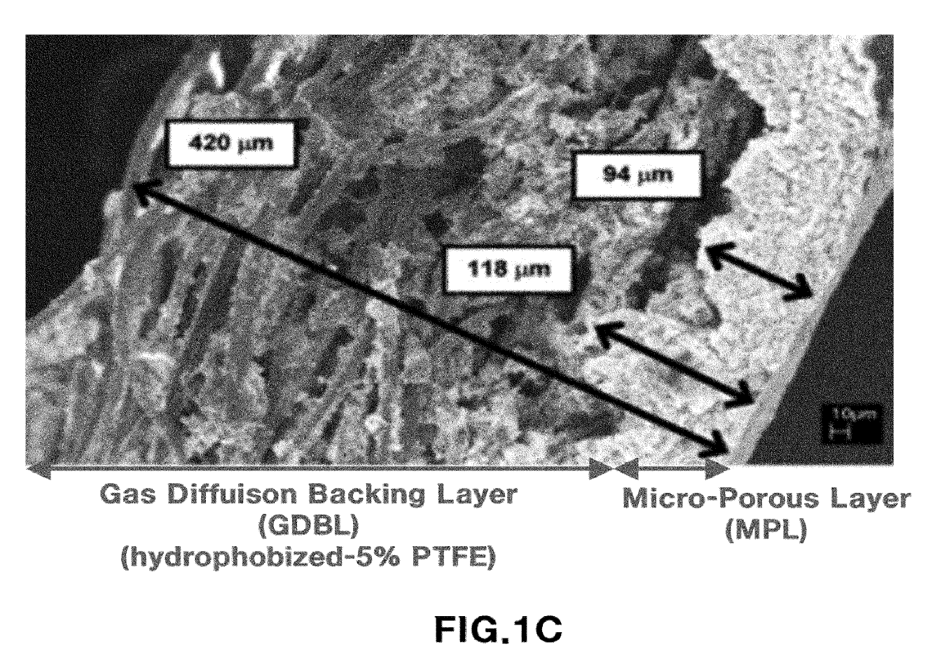

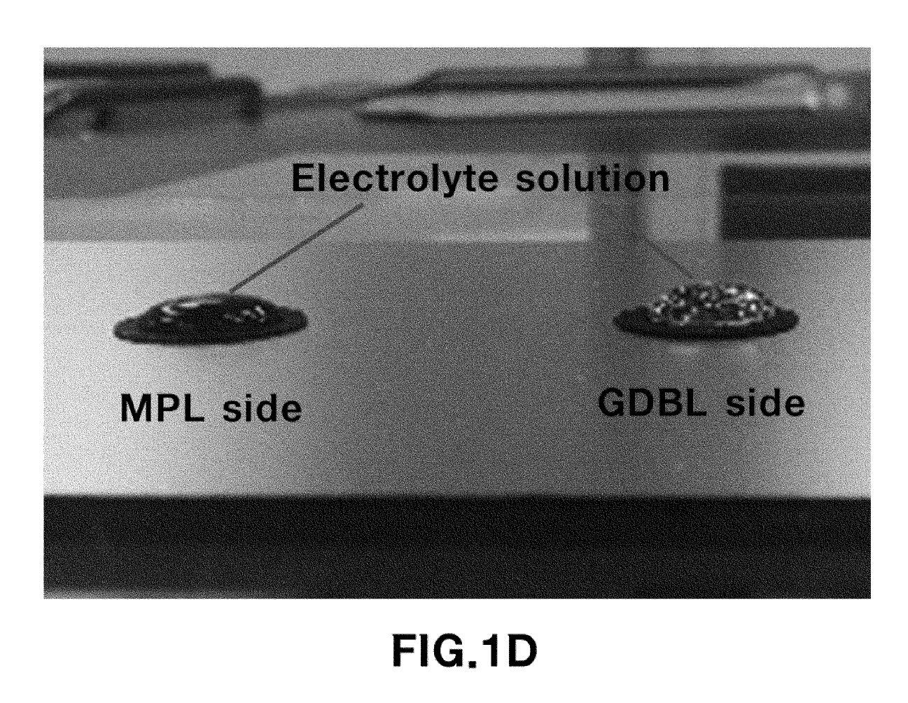

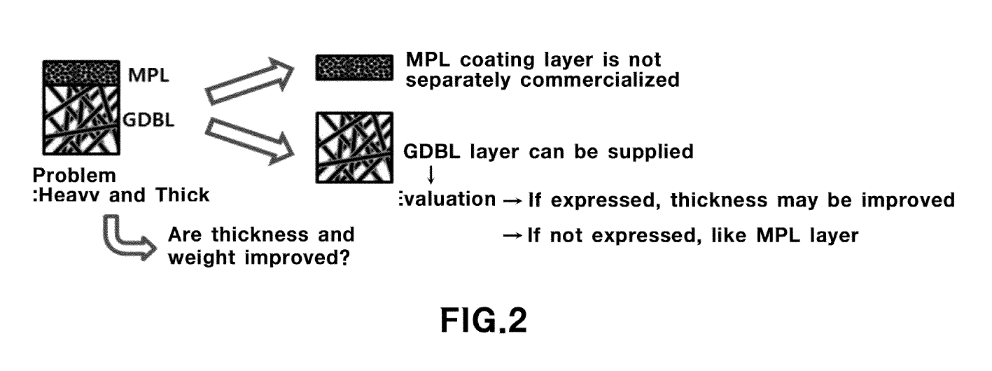

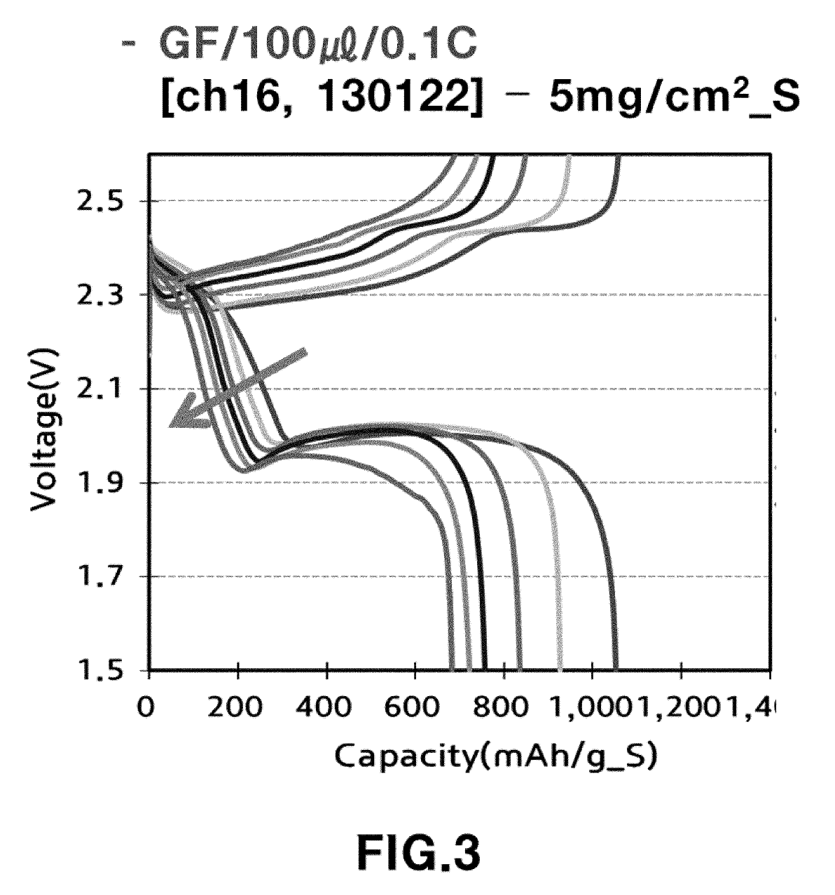

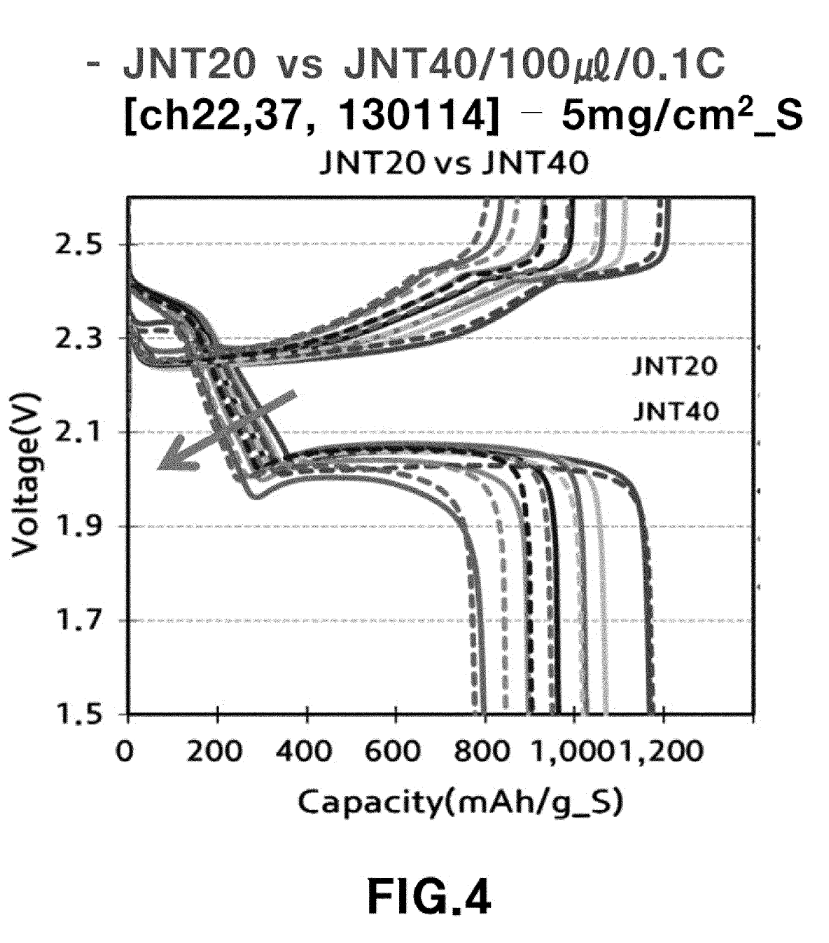

Characteristics of some of the aforementioned materials or performance of secondary batteries including some of the aforementioned materials is illustrated in FIG. 1A through FIG. 4. For example, FIGS. 1A-1D respectively show a low-magnification image, a high-magnification image, a cross sectional image, and a surface of carbon felt applicable to form a conductive and liquid-retaining structure employed by a secondary battery according to an embodiment of the present disclosure, FIG. 2 is constitution of a commercialized fuel cell GDL and design for using thereof as a battery according to an embodiment of the present disclosure, FIG. 3 is a graph showing capacity and life when a glass filter (GF) is used to form a conductive and liquid-retaining structure employed by a secondary battery according to an embodiment of the present disclosure, and FIG. 4 is a graph showing capacity and life (1 to 50 cycles) according to carbon paper thickness.

The thickness of the conductive structure for liquid-retention may be properly 5 to 1,000 μm, and more narrowly, it may be properly 50 to 500 μm. For life and reactivity, there is no need to be thick, and it may be properly 20 to 350 μm in thickness.

The conductive structure may be single structure or it may be laminated with several layers. Specific surface area and porosity may be controlled with various conductive structure constitutions.

In order to improve energy density, it is needed to increase the amount of the active material (high loading anode is needed). However, a Lithium sulfur system has a mechanism that the active material is melted and comes out to the electrolyte solution. Thus, in the case of the active material of high loading, there are defects that active material utilization is reduced and cell performance expression is difficult when compared with the low loading electrode with the same condition. Thus, in order to achieve high energy density, cell performance expression of the high loading electrode is needed.

When using the conductive structure of the present invention, the electrolyte solution with the amount enough to the high loading electrode may be retained. Further, in the way of retaining the electrolyte solution, there is a different mechanism from the existing cell where the PS (intermediate), which is melted and comes out from the anode, gets out to the cathode or other void volume, and causes capacity loss at the next time. The reason is that the amount getting out to the cathode and the void volume may be significantly reduced because the electrolyte solution having the PS may be also retained. Moreover, there is an advantage that performance of the high loading electrode cell can be expressed through the conductive structure.

Another characteristic of the present invention is that the liquid-retaining structure made from a conductive material functions as a reaction site, thereby exhibiting larger performance in the aspect of life than the structure, which simply retains the PS.

Although the high loading cell is expressed, battery life may not be extended correspondingly because the amount of the eluted PS is increased. Therefore, there is an advantage of improving life in the high loading cell because the conductive structure also plays a role of a reaction site.

### EXAMPLES

The following cell examples include Inventive Examples according to embodiments of the present disclosure but not intended to limit the same, and Comparative Examples.

### Example

### 1) Manufacture of Cell

A basic anode is manufactured by mixing VGCF:sulfur:PVdF=7:2:1 and then subjected to slurry casting.

A high loading cell is evaluated at the sulfur loading amount of 8 mg/cm², and a low loading cell is evaluated at the sulfur lading amount of 4 mg/cm².

An entire cell is evaluated by dividing the cells into a cell assembled with the conductive and liquid-retaining structure of the present invention as an Inventive Example and a cell without a conductive and liquid-retaining structure as a Comparative Example.

(Type of the used conductive and liquid-retaining structure: Carbon paper/thickness: 230 μm/porosity: 95%)

### 2) Cell Performance Evaluation

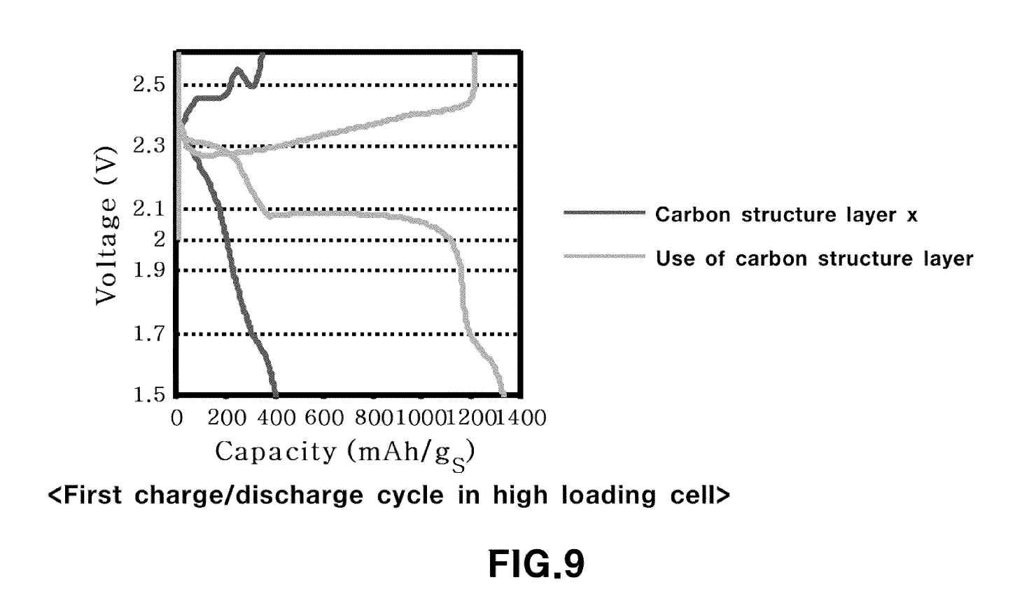

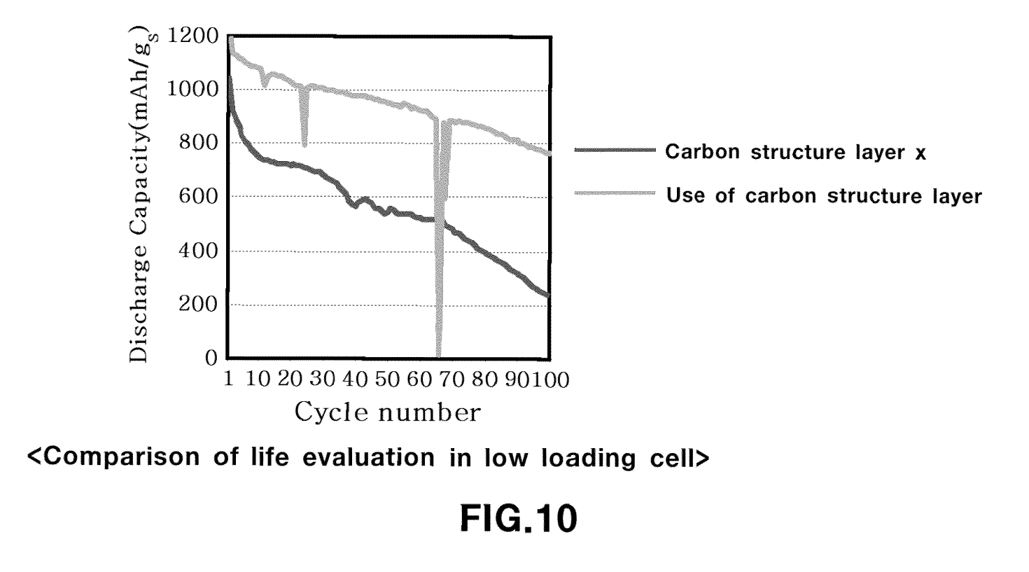

Graphs comparing the result of evaluating charging/discharging and life according to application of the carbon structure layer (liquid-retaining structure) are shown in FIG. 9 and FIG. 10.

According to the present invention, when comparing cell capacity whether using the conductive structure at high loading (5 mg/cm²_S or higher) or not, capacity is rarely expressed in the case of not using the conductive structure. It could be found that capacity is expressed up to 88% compared to the theoretical capacity is because availability of the active material is increased when using the conductive structure.

In addition, when comparing in life aspect, it could be found that in the case of not using the conductive structure in the low loading (2.5 mg/cm²_S) anode, residual discharge capacity was just 20% when charging/discharging 100 times, but in the case of using the conductive structure, residual discharge capacity was high as 67%.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A lithium-sulfur secondary battery comprising:
a cathode;
a separation membrane;
a-conductive and liquid-retaining structure; and
an anode,
wherein the conductive and liquid-retaining structure has a thickness of 5 to 1,000 μm, an areal weight of 10 to 120 g/m² range, and porosity of 70 to 95%.

2. The lithium-sulfur secondary battery of claim 1, wherein the conductive and liquid-retaining structure is selected from the group consisting of carbon paper, carbon felt, carbon veil, woven-carbon, carbon nanotube paper, and a laminated structure of at least two selected therefrom.

3. The lithium-sulfur secondary battery of claim 1, wherein the thickness of the conductive and liquid-retaining structure is 50 to 500 μm.

4. The lithium-sulfur secondary battery of claim 1, wherein the thickness of the conductive and liquid-retaining structure is 20 to 350 μm.

5. The lithium-sulfur secondary battery of claim 1, wherein the loading amount of the anode is 3 to 10 mg/cm².

6. A method for manufacturing a lithium-sulfur secondary battery, the method comprising:
forming a stack of cathode/separation membrane/conductive and liquid-retaining structure/anode,
wherein:
the conductive and liquid-retaining structure has a thickness of 5 to 1000 μm, an areal weight of 10 to 120 g/m² range, and porosity of 70 to 95%, and the conductive and liquid-retaining structure is laminated after casting an active material to the anode, and then assembled with the cathode and the separation membrane, or the conductive and liquid-retaining structure is assembled between the separation membrane and the anode in the cell assembly step.

7. The method of claim 6, wherein the conductive and liquid-retaining structure is selected from the group consisting of carbon paper, carbon felt, carbon veil, carbon film, carbon nanotube paper, and a laminated structure of at least two selected therefrom.

8. The method of claim 6, wherein the thickness is 50 to 500 μm.

9. The method of claim 6, wherein the thickness is 20 to 350 μm.

10. The method of claim 6, wherein the loading amount of the anode is 3 to 10 mg/cm².
